(19) United States
(12) Patent Application Publication
(10) Pub. No.: US 2015/0293379 A1
(43) Pub. Date: Oct. 15, 2015

(54) Temple Vent Lock Clip

(71) Applicant: Tenacious Holdings, Inc., St. Paul, MN (US)

(72) Inventors: Thomas Votel, Sunfish Lake, MN (US); Andrew Olson, Minneapolis, MN (US); Dominique Aris, Louisville, CO (US)

(21) Appl. No.: 14/552,584

(22) Filed: Nov. 25, 2014

Related U.S. Application Data
(60) Provisional application No. 61/979,750, filed on Apr. 15, 2014.

(51) Int. Cl. G02C 11/08; G02C 13/00

(52) U.S. Cl. CPC G02C 11/08; G02C 13/001

(57) ABSTRACT

The present disclosure is directed to a novel way to attach various accessories to the temple vents of protective eyewear. In one aspect of the disclosure; a clip with a male key portion is configured to attach accessories by rotationally locking the clip into a vent of a temple of a pair of protective eyewear, with the accessories attached to the clip.

### CLAIM OF BENEFIT TO PRIOR APPLICATIONS

This application claims the benefit of U.S. Provisional Application No. 61/979750 filed Apr. 25, 2014; and such application is hereby fully incorporated by reference herein.

### FIELD

The present invention relates generally to eyewear. More particularly, the present invention relates to an improved lock clip configured to attach to a vent in the temple of protective eyewear to tether accessories to the eyewear.

### BACKGROUND

1. Field of the Invention

Protective eyewear is used more and more frequently on construction sites, work zones, and in tree and yard work. Protective eyewear can inhibit loose debris from making its way into the eye of a person; and, can protect the eye from many projectiles. Because protective eyewear is often worn during physical activity, there is a need for protective eyewear that includes both a vent opening in the temple section of the eyewear to help prevent fogging, and that also provides the dual function of receiving a locking clip configured to tether various articles.

2. Description of Related Art

The use of protective eyewear for protecting the eyes of wearers from contact with wind, debris, chemicals and other foreign objects and irritants is widely known. Protective eyewear has long been used by skiers, laboratory workers, and machine operators, but has gained recent acceptance in many other fields such as with health professionals, construction workers, landscape maintenance workers and others who work in environments where the air carries contaminants or debris that may irritate or cause damage to the workers' eyes if left unprotected. As such, protective eyewear has many applications.

Although protective eyewear provides protection to the wearers' eyes, they also present certain problems that are bothersome or problematic to the wearer, depending on the environment in which the worker is employed. One such problem is fogging of the wearer's lens within the protective eyewear, which occurs when warm, moist air within the protective eyewear contacts a relatively cool lens. In many environments, such fogging is unacceptable and dangerous.

Further, it is often a desire on the part of the protective eyewear wearer to attach items to the temples of the protective eyewear, such as a head strap for securing the eyewear, for example.

It is known to provide protective eyewear with ventilation to keep the lens from fogging. For example, it is known from U.S. Pat. No. 7,036,927 to Kopfer, to provide apertures around the perimeter of the lens area to inhibit the fogging or misting of the lens. It is also known to provide removable clips that attach to the protective eyewear to retain straps. See for example U.S. Pat. No. 7,162,756 to Canavan. There is a long standing, unfulfilled need, however, for protective eyewear with a clip attachment with greater utility with less manufacturing expense.

### SUMMARY

The temple vent lock clip invention consists of two primary parts; a clip, that preferably includes a T-shaped key on one end, and a vent opening in a temple section of the eyewear configured to receive the clip key. The clip is configured to be secured by rotationally locking the clip key into a properly configured vent opening. The other end of the clip is configured to hold and retain items. For example, an elastic strap, a set of ear plugs, a lanyard, a carabineer, or ear buds may be connected to the clip. Once the clip is inserted into the vent and locked by rotation, the accessory would be secured to the protective eyewear and be readily accessible to the wearer. Preferably each temple would consist of multiple vents where only one vent would be utilized when the clip is in place.

### BRIEF DESCRIPTION OF THE DRAWINGS

FIGS. 1 is a top view of clip 10.

FIG. 2 is a side elevation view of clip 10.

FIG. 3a is an outside elevation view of temples 19 of protective eyewear 31.

FIG. 3b is an inside elevation view of temples 19 of protective eyewear 31.

FIG. 3c is an outside elevation view of temples 19 with clip 10 engaged in vent 21.

FIG. 3d is an outside elevation view of temples 19 with clip 10 locked into vent 21.

FIG. 4 is a top view of clip 10 configured to secure sound ear bud 38.

FIG. 5 is a top view of clip 10 configured to secure retention strap 40.

FIG. 6 is a top view of clip 10 configured to secure clip 43.

FIG. 7 is a top view of clip 10 configured to secure earplug 47.

FIG. 8 is a top view of protective eyewear 31 with strap 40 attached.

FIG. 9 is a perspective view of protective eyewear 31 with strap 40 attached.

FIG. 10 is a side elevation view of protective eyewear 31 with strap 40 attached.

### DETAILED DESCRIPTION OF THE PREFERRED EMBODIMENT

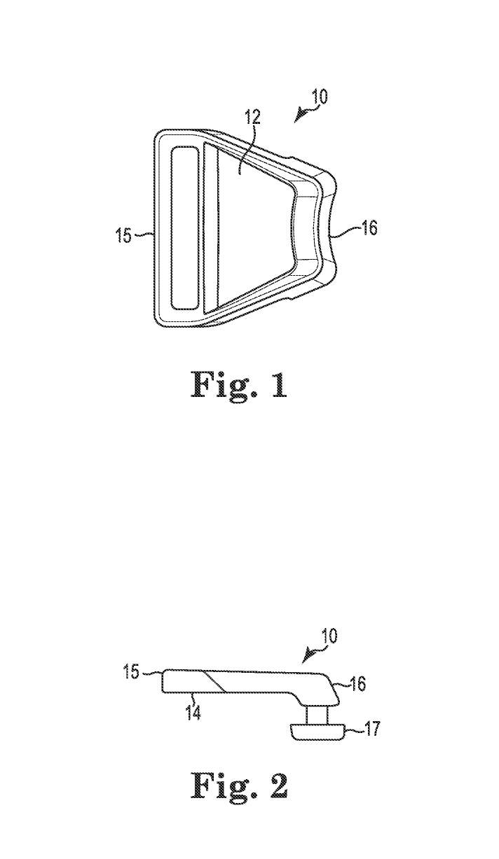

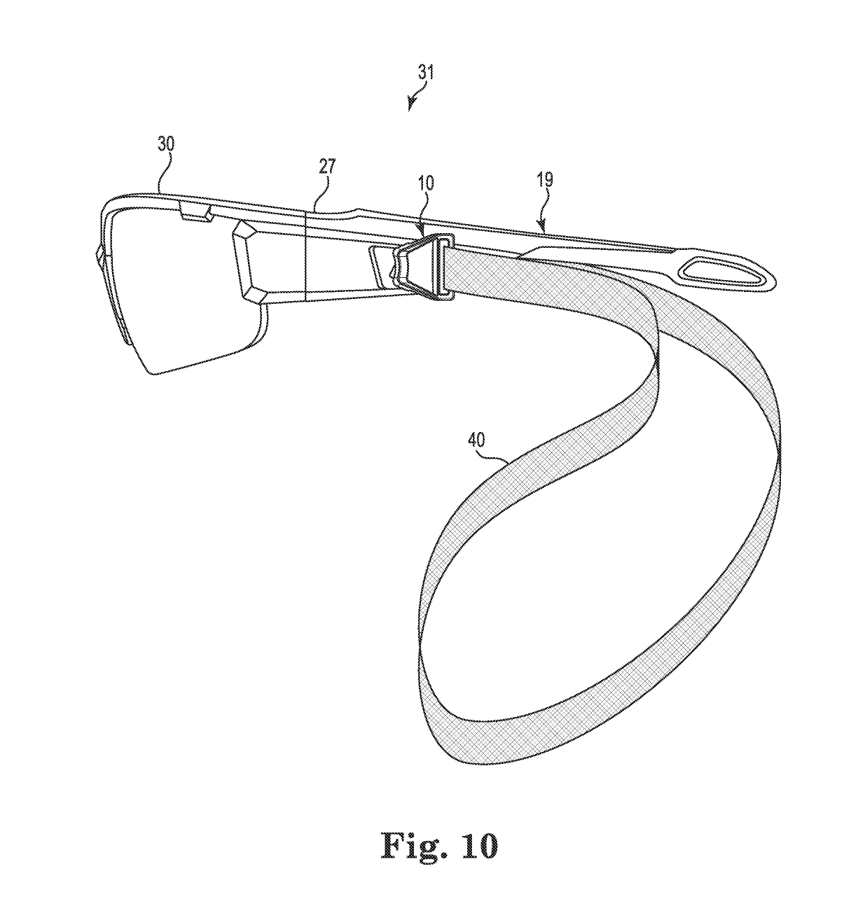

The temple vent lock clip invention that engages a vent of a temple is disclosed and described with reference to the FIGS. 1-10. Lock clip 10 is preferably configured in a generally triangular shape with top surface 12, bottom surface 14, back end 15 and front end 16. Protruding generally perpendicularly from bottom surface 14, at front end 16, is key 17. Key 17 is configured to fit and preferably rotationally lock into temples 19. Key 17 is preferably T-shaped, but other shapes may be utilized without departing from the scope of the invention herein disclosed.

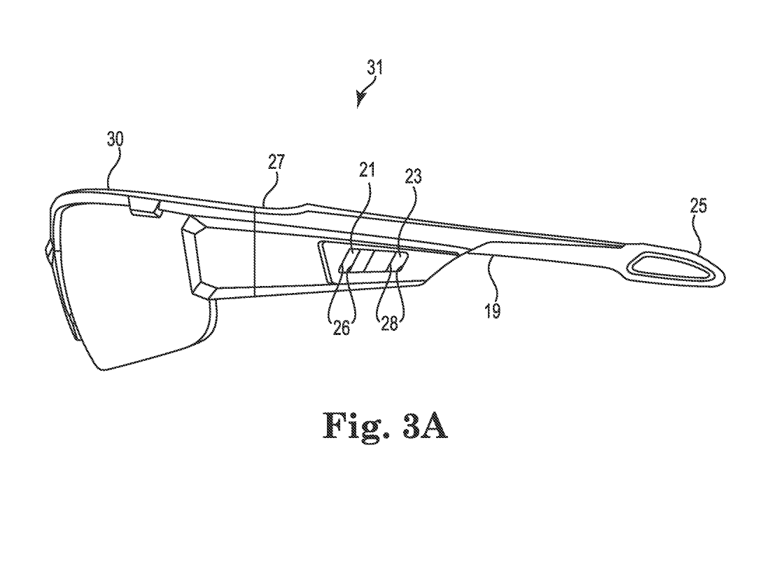

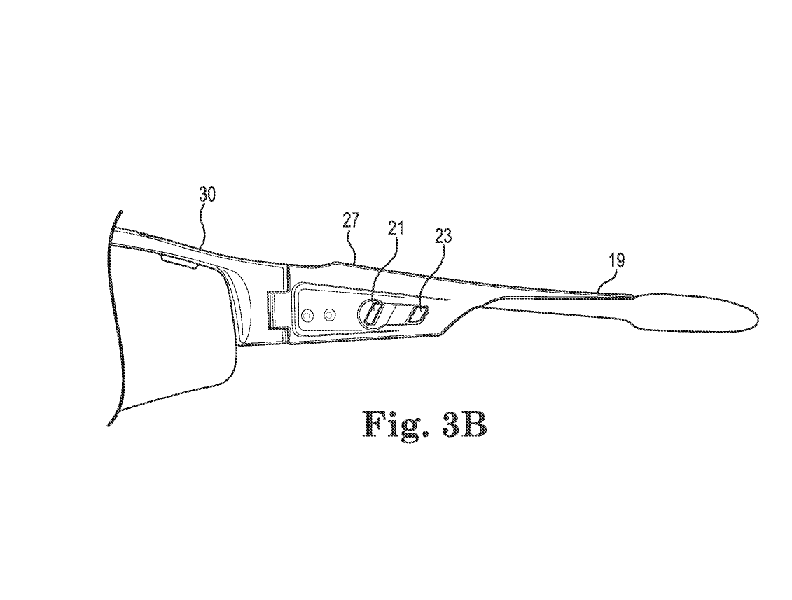

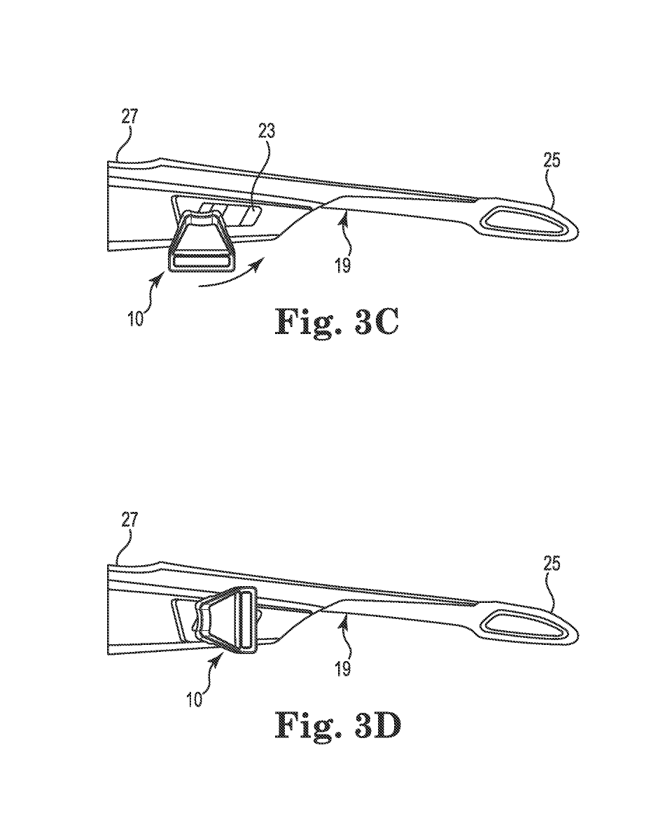

Referring now to FIGS. 3a -3d, temple 19 is generally constructed with an ear engaging end 25 and a frame engaging end 27. Vent 21 or 23, or both, can be configured to except key 17.

It is preferred that each temples be constructed with two or more vents, so that at least one vent will remain unobstructed when lock clip 10 is locked into place. It is contemplated that frame 30 of protective eyewear 31 and the frame engaging end 25 may be one piece. Vents 21 and 23 are preferably rectangular in shape with beveled side walls 26 and 28 to assist in airflow and venting. To optimize venting of frame 30, it is preferred that vents 21 and 23 be positioned forward, more closely to frame engaging end 27 of temple 19. FIG. 3b depicts area 24 of vent 21 configured to allow key 17 to rotate within, in this example, vent 21. Vent 23 may be configured to accept key 17 of clip 10 in a similar manner, if desired. FIG. 3c depicts key 17 of clip 10 engaged in vent 21, but not yet locked. Clip 10 is locked into place by rotating clip 10 about 90 degrees. FIG. 3d shows clip 10 in a locked position after the rotation indicated in FIG. 3c.

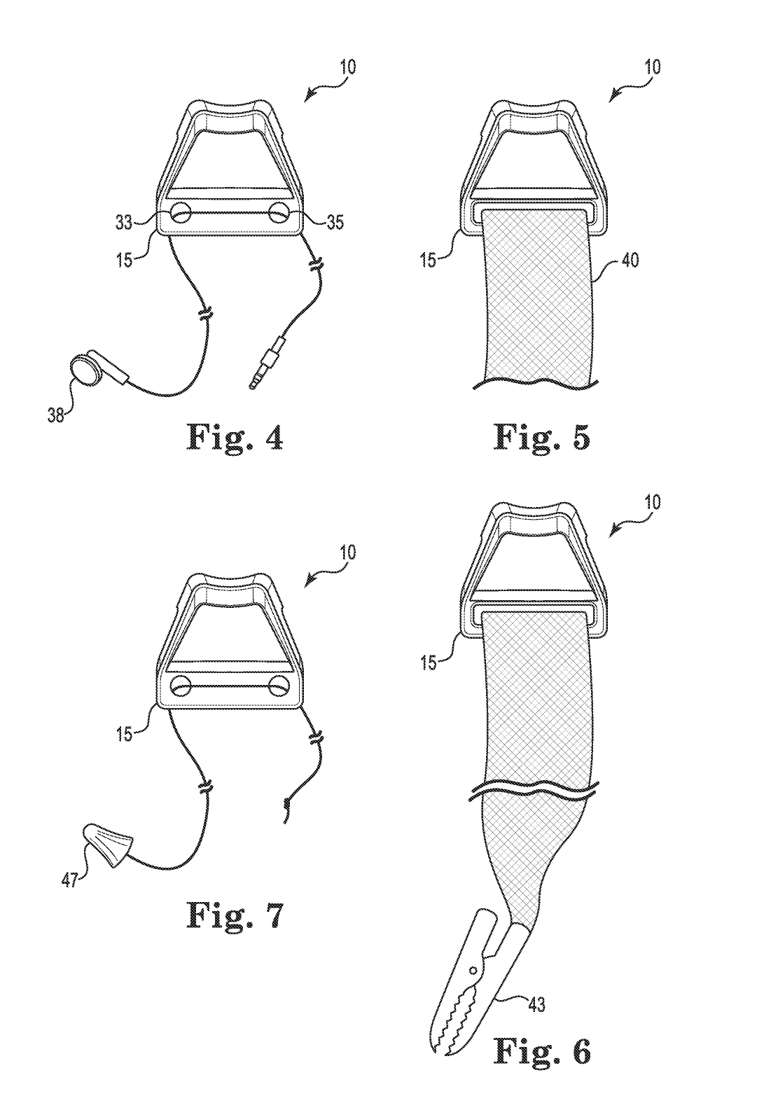

Referring to FIGS. 4 through 7, lock clip 10 may be preferably configured near back end 15 to accept a variety of attachments. As shown in FIG. 4, apertures 33 and 35 in lock clip 10 may be used to hold earbud 38 for phone or music applications. As shown in FIG. 5, a pair of lock clips 10 may be configured to hold elastic or non-elastic strap 40 for maintaining protective eyewear 31 securely on the head of a user (only one clip shown). Referring now to FIG. 6, lock clip 10 may be configured to receive clip 43, or a carabineer (not shown). Referring now to FIG. 7, a pair of lock clips 10 may be configured to hold ear plugs 47 (only one clip and ear plug shown).

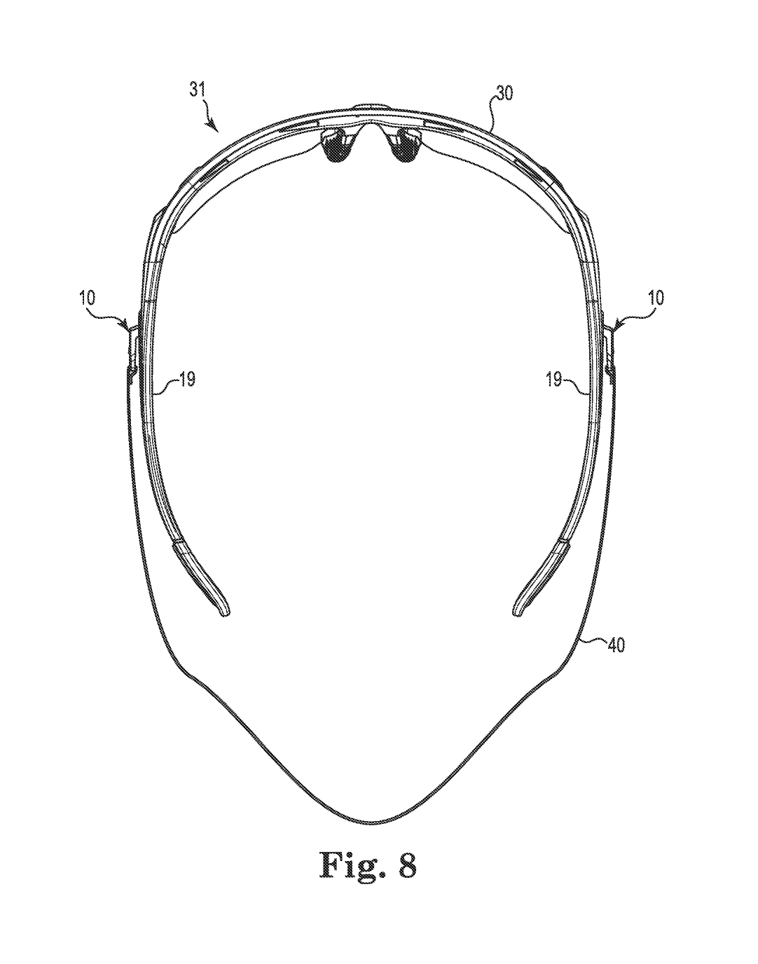

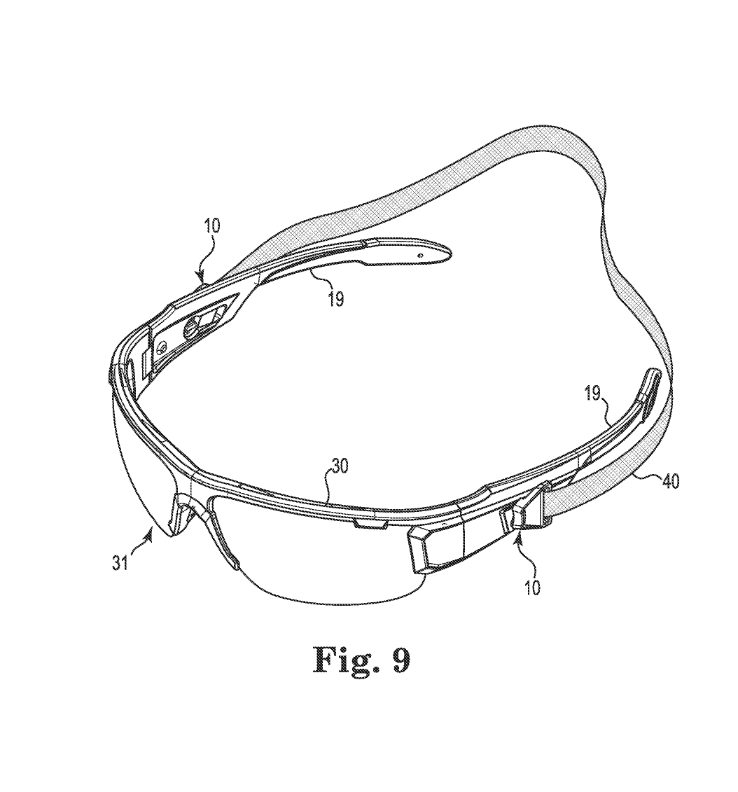

FIGS. 8 and 9 disclose protective eyewear 31 with head strap 40 attached at both temples 19. Manufacturing costs can be reduced by the dual purpose of the temples vents performing both a venting and a clip securing function, eliminating the need for additional clip securing apparatus incorporated into the temples or eyewear.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. For example, the dimensions and proportions indicated in the figures may be altered without departing from the scope of the invention.

For purposes of interpreting the claims for the present invention, it is expressly intended that the provisions of Section 112, sixth paragraph of 35 U.S.C. are not to be invoked unless the specific terms “means for” or “step for” are recited in a claim.

1. Protective eyewear comprising:
a pair of temples connected to a frame;
each temple defining at least two vent openings;
a clip having a protruding key portion;
at least one vent opening on each temple configured to receive the clip key portion; and
wherein the clip key portion is configured to rotationally secure the clip into the at least one vent opening.

2. The protective eyewear of claim 1; further comprising a portion of the clip configured to accept an accessory.

3. The protective eyewear of claim 2 wherein the accessory is a strap.

4. The protective eyewear of claim 2 wherein the accessory is an ear bud.

5. The protective eyewear of claim 2 wherein the accessory is an ear plug.

6. The protective eyewear of claim 2 wherein the accessory is a clip.

7. An eyewear temple comprising:
a temple defining at least two vent openings;
a clip having a key portion and an accessory receiving portion;
at least one vent opening configure to receive the clip key portion;
the clip key portion configured to rotate within the at least one vent opening; and
wherein the clip is secure into position on the eyewear temple after rotation of the clip.

8. The eyewear temple of claim 8 wherein the rotation is about 90 degrees.

9. The eyewear temple of claim 7 wherein the clip is generally triangular in shape.

10. The eyewear temple of claim 7 where each vent opening is generally rectangular in shape.

11. The eyewear temple of claim 7 wherein a strap is connected to the accessory receiving portion of the clip.

12. A method for connecting an accessory to the temples of protective eyewear comprising:
Attaching an accessory to one end of a clip;
Inserting a key portion; located at the other end of the clip into one of two vents located in a temple of protective eyewear; and
rotating the clip about 90 degrees to secure the key portion into one of the two vents.
